(19) United States
(12) Patent Application Publication
(10) Pub. No.: US 2006/0123239 A1
(43) Pub. Date: Jun. 8, 2006

(54) Biometric based user authentication with syndrome codes

(76) Inventors: Emin Martinian, Arlington, MA (US); Anthony Vetro, Cambridge, MA (US)

Correspondence Address: Patent Department;Mitsubishi Electric Research Laboratories, Inc., 201 Broadway, Cambridge, MA, 02139, US

(21) Appl. No.: 11/006,308

(22) Filed: Dec. 7, 2004

(51) Int. Cl. H04K 1/00

(52) U.S. Cl. 713/186

(57) ABSTRACT

Biometric parameters acquired from human faces, voices, fingerprints, and irises are used for user authentication and access control. Because the biometric parameters are continuous and vary from one reading to the next, syndrome codes are applied to determine biometric syndromes. The biometric syndromes can be stored securely, while tolerating an inherent variability of biometric data. The stored biometric syndrome is decoded during user authentication using biometric parameters acquired at that time. Specifically, during enrollment, enrollment biometric parameters are acquired from a user and encoded as a syndrome. A hash function is applied to the syndrome to produce an enrollment hash. The syndrome and hash as stored in a database. During user authentication, the enrollment syndrome is decoded using a syndrome decoder and authentication biometric parameters of the user to produce decoded biometric parameters. The hash function is applied to the decoded biometric parameters to produce an authentication hash. The authentication hash and the enrollment hash are compared to determine whether user access is granted.

### FIELD OF THE INVENTION

The invention relates generally to the fields of data compression and cryptography, and more particularly to storing biometric parameters for user authentication.

### BACKGROUND OF THE INVENTION

Conventional Password Based Security Systems

Conventional password based security systems typically include two phases. Specifically, during an enrollment phase, users select passwords, which are stored on an authentication device, such as server. To gain access to resources or data during an authentication phase, the users enter their passwords, which are verified against the stored versions of the passwords. If the passwords are stored as plain text, then an attacker who gains access to the system could obtain every password. Thus, even a single successful attack can compromise the security of the entire system.

As shown in FIG. 1, a conventional password based security system 100 stores 1 15 encrypted 110 passwords 101 in a password database 120 during an enrollment phase 10. Specifically, if X is password 101 to be stored 115, the system 100 actually stores ƒ(X) where ƒ(.) is some encryption or hash function 110. During an authentication phase 20, a user enters a candidate password Y 102, the system determines 130 ƒ(Y), and only grants access 150 to the system where ƒ(Y) matches 140 the stored password ƒ(X), otherwise, access is denied 160.

As an advantage, encrypted passwords are useless to an attacker without the encryption function, which are usually very difficult to invert.

Conventional Biometric Based Security Systems

A conventional biometric security system has the same vulnerability as a password based system, which stores unencrypted passwords. Specifically, if the database stores unencrypted biometric parameters, then the parameters are subject to attack and misuse.

For example, in a security system using face recognition system or voice recognition, an attacker could search for biometric parameters similar to the attacker. After suitable biometric parameters are located, the attacker could modify the parameters to match the appearance or voice of the attacker to gain unauthorized access. Similarly, in security system using fingerprint or iris recognition, the attacker could construct a device that imitates a matching fingerprint or iris to gain unauthorized access, e.g., the device is a fake finger or eye.

It is not always possible to encrypt biometric parameters due to their inherent variability over time. Specifically, biometric parameters X are entered during the enrollment phase. The parameters X are encrypted using an encryption or hashing function ƒ(X), and stored. During the authentication phase, the biometric parameters obtained from the same user can be different. For example, in a security system using face recognition, the user's face can have a different orientation with respect to the camera during enrollment than during authentication. Skin tone, hairstyle and facial features can change. Thus, during authentication, the encrypted biometric parameters will not match with any stored parameters causing rejection.

Error Correcting Codes

An (N, K) error correcting code (ECC) C, over an alphabet Q, includes Q^{K} vectors of length N. A linear (N, K) ECC can be described either by using a generator matrix G, with N rows and K columns, or by using a parity check matrix H, with N-K rows and N columns. The name ‘generator matrix’ is based on the fact that a codeword expressed as a vector w, can be generated from any length K input row vector v, by right multiplying the vector v by the matrix G according to w=vG. Similarly, to check if the vector w is a codeword, one can check whether Hw^{T}=0, where a column vector w^{T} is a transpose of the row w.

In the standard use of error correcting codes, an input vector v is encoded into the vector w, and either stored or transmitted. If a corrupted version of the vector w is received, a decoder uses redundancy in the code to correct for errors. Intuitively, the error capability of the code depends on the amount of redundancy in the code.

Slepian-Wolf, Wyner-Ziv, and Syndrome Codes

In some sense, a Slepian-Wolf (SW) code is the opposite of an error correcting code. While an error correcting code adds redundancy and expands the data, the SW code removes redundancy and compresses the data. Specifically, vectors x and y represent vectors of correlated data. If an encoder desires to communicate the vector x to a decoder that already has the vector y, then the encoder can compress the data to take into account the fact that the decoder has the vector y.

For an extreme example, if the vectors x and y are different by only one bit, then the encoder can achieve compression by simply describing the vector x, and the location of the difference. Of course, more sophisticated codes are required for more realistic correlation models.

The basic theory of SW coding, as well as a related Wyner-Ziv (WZ) coding, are described by Slepian and Wolf in “Noiseless coding of correlated information sources,” IEEE Transactions on Information Theory, Vol. 19, pp. 471-480, July 1973, and Wyner and Ziv in “The rate-distortion function for source coding with side information at the decoder,” IEEE Transactions on Information Theory, Vol. 22, pp. 1-10, January 1976. More recently, Pradhan and Ramchandran described a practical implementation of such codes in “Distributed Source Coding Using Syndromes (DISCUS): Design and Construction,” IEEE Transactions on Information Theory, Vol. 49, pp. 626-643, March 2003.

Essentially, the syndrome codes work by using a parity check matrix H with N-K rows and N columns. To compress a binary vector x of length N to a syndrome vector of length K, determine S=Hx. Decoding often depends on details of the particular syndrome code used. For example, if the syndrome code is trellis based, then various dynamic programming based search algorithms such as the well known Viterbi algorithm can be used to find the mostly likely source sequence X corresponding to the syndrome S, and a sequence of side information as described by Pradhan et al.

Alternatively, if low density parity check syndrome codes are used, then belief propagation decoding can be applied as described in “On some new approaches to practical Slepian-Wolf compression inspired by channel coding” by Coleman et al., in Proceedings of the Data Compression Conference, March, 2004, pages 282-291.

Prior Art

Prior art related to the current invention falls into two categories. First, there is a great deal of prior art describing the detailed feature extraction, recording, and use of biometric parameters unrelated to the secure storage of such biometric parameters. Because our invention is concerned with secure storage, and largely independent of the details of how the biometric parameters are acquired, details of this category of prior art are omitted.

The second class of prior art, which is relevant to the invention, includes the following systems designed for secure storage and authentication of biometrics, “Method and system for normalizing biometric variations to authenticate users from a public database and that ensures individual biometric data privacy,” U.S. Pat. No. 6,038,315; “On enabling secure applications through off-line biometric identification,” by Davida, G. I., Frankel, Y., Matt, B. J. in Proceedings of the IEEE Symposium on Security and Privacy, May 1998; “A Fuzzy Vault Scheme,” by Juels, A., Sudan, M., in Proceedings of the 2002 IEEE International Symposium on Information Theory, June 2002; “Multi-factor biometric authenticating device and method,” U.S. Pat. No. 6,363,485.

FIG. 2 shows some of the details of the basic method described in U.S. Pat. No. 6,038,315. In the enrollment phase 210, biometric parameters are acquired in the form of a sequence of bits denoted E 201. Next, a random codeword W 202 is selected from a binary error correcting code and additively combined with the parameters E using an exclusive OR (XOR) function 220 to produce a reference R 221. Optionally, the reference R can be further encoded 230. In any case, the reference R is stored in a password database 240.

In the authentication phase 220, a biometric parameters E′ 205 are presented for authentication. The method determines 250 the XOR of R with E′ to essentially subtract the two to obtain Z=R−E′=W+E−E′ 251. This result is then decoded 260 with the error correcting code to produce W′ 261. In step 270, if W′ matches W, then access is granted 271, and otherwise, access is denied 272.

That method essentially measures the Hamming distance, i.e., the number of bits that are different, between the enrolled biometric E 201, and the authentication biometric E′ 205. If the difference is less than some predetermined threshold, then, then access is granted. Because the method stores only the reference R, and not the actual biometric parameters E, the method is secure.

Davida et al. and Juels et al. describe variations of the method shown in FIG. 2. Specifically, both encode the biometric data with an error correcting code during the enrollment phase followed by an operation to secure the resulting codeword. Davida et al. hide the codeword by only sending the check bits, while Juels et al. add some amount of noise referred to as ‘chaff’.

U.S. Pat. No. 6,363,485 describes a method for combining biometric data with an error correcting code and some secret information, such as a password or personal identification number (PIN), to generate a secret key. Error correcting codes, such as Goppa codes or BCH codes, are employed with various XOR operations.

Problems with the Prior Art

First, the bit-based prior art method provides dubious security. In addition, biometrics are often real-valued or integer-valued, instead of binary valued. The prior art assumes generally that biometrics are composed of uniformly distributed random bits, and that it is difficult to determine these bits exactly from the stored biometric. In practice, biometric parameters are often biased, which negatively affect security. Also, an attack can cause significant harm, even if the attack recovers only an approximate version of the stored biometric. Prior art methods are not designed to prevent the attacker from estimating the actual biometric from the encoded version.

For example, U.S. Pat. No. 6,038,315 relies on the fact that the reference value R=W+E effectively encrypts the biometric E by adding the random codeword W. However, that method achieves poor security. There are a number of ways to recover E from R. For example, if the vector E has only a few bits equal to one, then the Hamming distance between R and the W is small. Thus, an error correction decoder could easily recover W from R, and hence also recover E. Alternatively, if the distribution of codewords is poor, e.g., if the weight spectrum of the code is small and many codewords are clustered around the all zero vector, then an attacker could obtain a good approximation of E from R.

Second, in addition to dubious security, prior art methods have the practical disadvantage of increasing the amount of data stored. Because biometric databases often store data for many individual users, the additional storage significantly increases the cost and complexity of the system.

Third, many prior art methods require error correction codes or algorithms with a high computational complexity. For example, the Reed-Solomon and Reed-Muller decoding algorithms of the prior art generally have a computational complexity, which is at least quadratic, and often higher in the length of the encoded biometric.

### SUMMARY OF THE INVENTION

Biometric parameters, which are acquired from human faces, voices, fingerprints and irises for example, are often used for user authentication and data access control. Biometric parameters cannot be stored in hashed or encrypted forms in databases as is done with passwords because the parameters are continuous and can vary from one reading to the next for the same user. This makes biometric databases subject to “break once run everywhere” attacks.

The invention uses syndrome codes based on Wyner-Ziv and Slepian-Wolf coding to determine biometric syndromes, which can be stored securely, while still tolerating the inherent variability of biometric data.

Specifically, the biometric syndromes according to the invention have the following properties. First, the syndromes effectively hide or encrypt information about the original biometric characteristics so that if the syndrome database is compromised, the stored syndromes are of little use in circumventing the security of the system. Second, each stored syndrome can be decoded to yield the original biometric parameters, and to authenticate a user.

### BRIEF DESCRIPTION OF THE DRAWINGS

FIG. 1 is a block diagram of prior art password based security system;

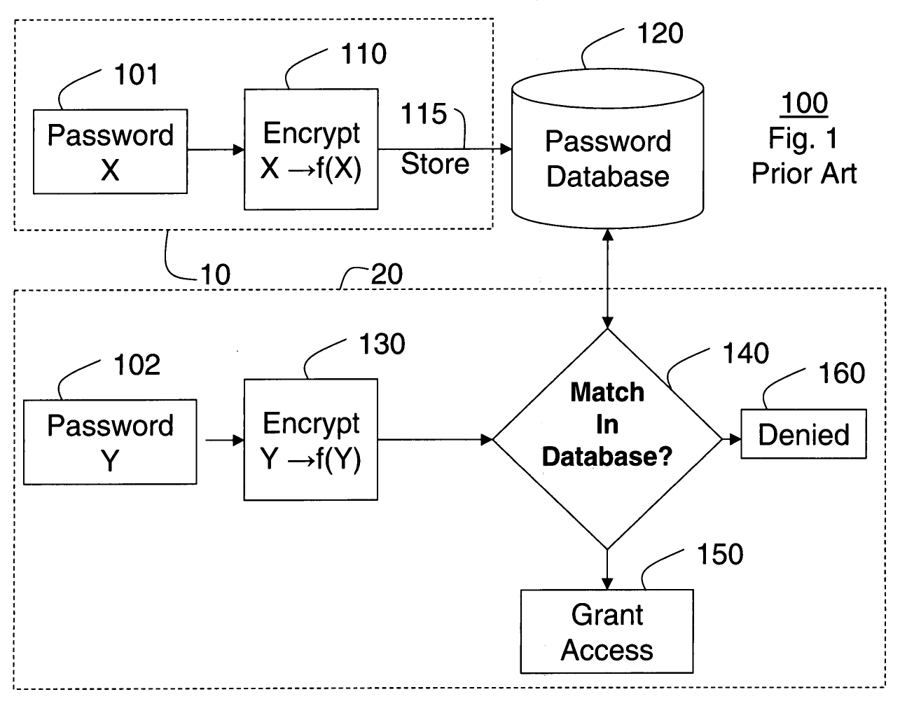

FIG. 2 is a block diagram of prior art biometric based security system; and

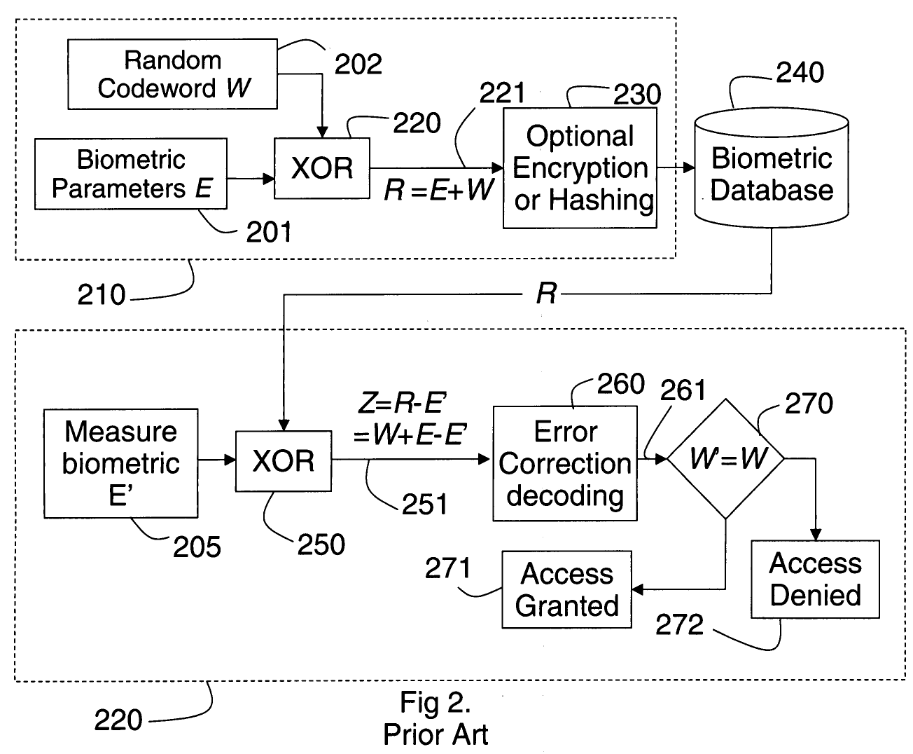

FIG. 3 is a block diagram of a biometric security system according to the invention.

### DETAILED DESCRIPTION OF THE PREFERRED EMBODIMENT

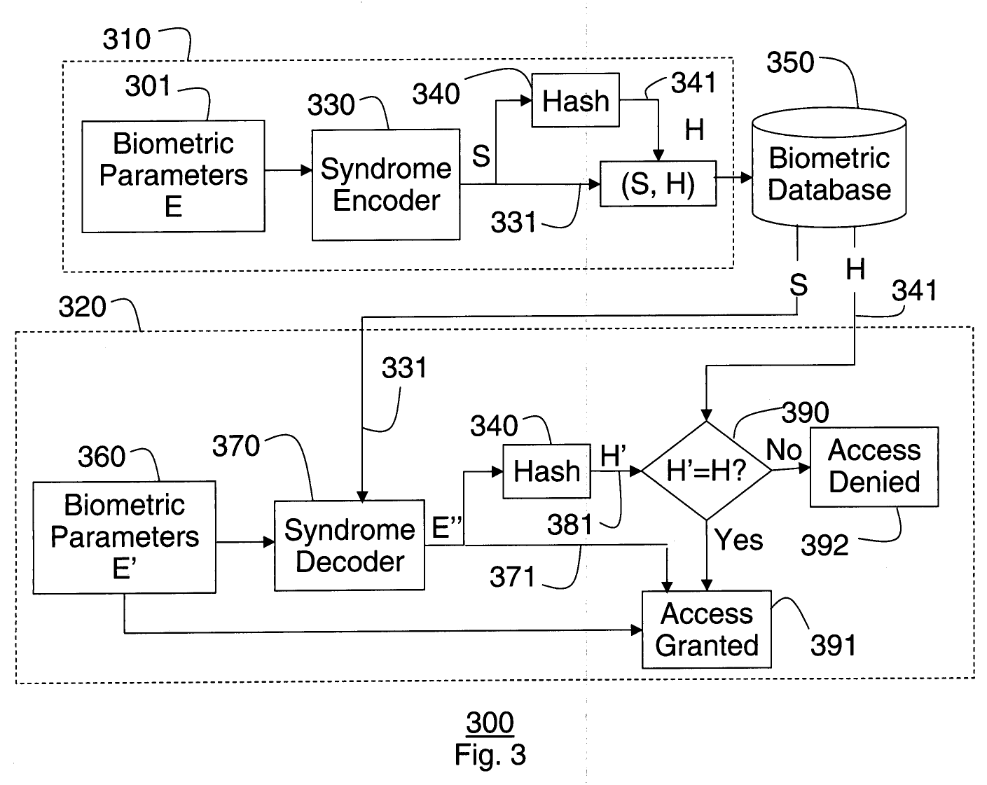

FIG. 3 shows a biometric security system according to our invention. The method according to our invention compresses biometric parameters with a syndrome code to produce a compressed syndrome. Unlike conventional compression, the syndrome produced by the syndrome code bears no relationship to the original biometric data. Therefore, the stored syndrome cannot be used to decode an approximation of the original biometric parameters. The resulting compressed syndrome and a hash of the syndrome are stored in a biometric database.

To authenticate a user, biometric parameters are measured again. The biometric parameters are combined with the stored syndrome to decode the original biometric parameters. If syndrome decoding fails, the user is denied access. If syndrome decoding succeeds, then the original biometric parameters are used to verify the authenticity of the user.

Enrollment Phase

In an enrollment phase 310, biometric data are acquired of a user. For example, the data are an image of a face, a recording of speech, an image of a fingerprint, or a scan of an iris. A feature vector is extracted from the measured biometric data. The feature vector forms enrollment biometric parameters 301. Methods for extracting features from various forms of biometric data are well known in the art, as described above.

The biometric parameters E 301 are encoded using a syndrome encoder 330 to produce an enrollment syndrome S 331. Next, a message authentication code or hash function is applied 340 to the enrollment syndrome S to produce an enrollment hash H 341. The hash function can be the well-known MD5 cryptographic hash function described by Ron Rivest in “The MD5 Message Digest Algorithm,” RFC 1321, April 1992. The enrollment syndrome—hash pair (S, H) 331, 341 is stored in a biometric database 350.

Any type of syndrome code, e.g., the SW code or the WZ code described above, can be used. The preferred embodiment of the invention uses codes derived from so-called “repeat-accumulate codes,” namely “product-accumulate codes,” and codes that we call “extended Hamming-accumulate codes.”

We refer generally to these as serially concatenated accumulate (SCA) codes. For more information on these classes of codes in a general sense, see J. Li, K. R. Narayanan, and C. N. Georghiades, “Product Accumulate Codes: A Class of Codes With Near-Capacity Performance and Low Decoding Complexity,” IEEE Transactions on Information Theory, Vol. 50, pp. 31-46, January 2004; M. Isaka and M. Fossorier, “High Rate Serially Concatenated Coding with Extended Hamming Codes,” submitted to IEEE Communications Letters, 2004; and D. Divsalar and S. Dolinar, “Concatenation of Hamming Codes and Accumulator Codes with High Order Modulation for High Speed Decoding,” IPN Progress Report 42-156, Jet Propulsion Laboratory, Feb. 15, 2004.

U.S. patent application Ser. No. 10/928,448, “Compressing Signals Using Serially-Concatenated Accumulate Codes,” filed by Yedidia, et al. on Aug. 27, 2004, incorporated herein by reference, describes the operation of our preferred syndrome encoder based on SCA codes as used by the present invention.

Our syndrome encoder 330 for the biometric parameters 301 has a number of advantages. The syndrome encoder 330 can operate on integer-valued inputs. In contrast, prior art encoders generally operate on binary valued inputs. The syndrome encoder has very high compression rates to minimize the storage requirements of the biometric database 350. The syndrome encoder is rate-adaptive, and can operate in an incremental fashion. More bits can be sent as necessary without wasting information in syndrome bits sent previously.

Authentication Phase

In an authentication phase 320, biometric data are again acquired from the user. Features are extracted to obtain authentication biometric parameters E′ 360. The database 350 is searched to locate the matching enrollment syndrome S 331 and enrollment hash H 341 for this user.

The search can check every entry (S-H pairs) in the database 350, or a heuristically ordered search can be used to accelerate the process of finding a matching entry. Specifically, if we denote the i^{th} syndrome-hash pair in the database as (Sᵢ, Hᵢ), then an exhaustive search first applies syndrome decoding to E′ and S₁ and compares the hash of the syndrome decoder output to H₁. If access is denied, the same process is attempted with (S₂, H₂), then (S₃, H₃), etc. until all entries have been tried or access was granted.

If side information such as an enrollment user-name is available, then the side information can be used to accelerate the search. For example, the hash of the enrollment user-name is stored with the pair S and H during the enrollment phase. Then, in the authentication phase, the user supplies an authentication user-name, and the system determines the hash of the authentication user-name, and search the database for an S-H pair with a matching hashed enrollment user-name, and attempts to authenticate E′ with the resulting S-H pair.

Specifically, a syndrome decoder 370 is applied to the enrollment syndrome S, with the authentication parameters E′ 360 acting as 'side′ information. Syndrome decoders are known in the art generally. Typically, decoders that use belief propagation or turbo codes have excellent performance with low complexity. An output of the syndrome decoder 370 are decoded enrollment parameters E″ 371. The decoded value E″ 371 is an estimate of the original biometric parameter E 301 used to produce the syndrome S 331. The hash function 340 is applied to E″ 371 to produce an authentication hash H′ 381.

The enrollment and authentication values H 341 and H′ 381 are compared 390. If the values do not match, then access is denied 392. Otherwise, the value E″ 381 substantially matches the original biometric E 301. In this case, the user can be granted access 391.

In addition, a direct comparison can be made between the decoded parameters E″ 381 and the authentication biometric parameters E′ 360 to authenticate the user. For example, if E′ and E″ correspond to biometric parameters in a face recognition system, conventional algorithms for comparing the similarity between faces could be applied to the parameters E′ and E″.

Effect of the Invention

The invention achieves secure user authentication based on biometric parameters. The invention is secure because syndromes are stored instead of original biometric data. This prevents an attacker who gains access to the database from learning the underlying biometric data.

It is possible to bound a best possible estimate of an original biometric parameters E, which an attacker can make using only the syndrome S, using conventional tools from the well known problem of multiple descriptions, e.g., see V. K. Goyal, “Multiple description coding: compression meets the network,” IEEE Signal Processing Magazine, Volume: 18, pages 74-93, September 2001. Furthermore, it is possible to develop these bounds whether a quality of the estimate is measured via absolute error, squared error, weighted error measures, or any arbitrary error function. In contrast, all prior art methods are based on binary values. There, security depends on the Hamming distance.

Essentially, the security of the syndrome S is due to the fact that it is a compressed version of the original biometric parameter E. Furthermore, this compressed representation corresponds to the “least significant bits” of E. Using well known tools from data compression theory, it is possible to prove that if a syndrome code with a high compression is used, then these least significant bits can at best yield a poor estimate of the original parameters E, for example, see Effros “Distortion-rate bounds for fixed- and variable-rate multiresolution source codes,” IEEE Transactions on Information Theory, volume 45, pages 1887-1910, September 1999, and Steinberg and Merhav, “On successive refinement for the Wyner-Ziv problem,” IEEE Transactions on Information Theory, volume 50, pages 1636-1654, August 2004.

Second, the invention is secure because forgery is at least as difficult as finding a collision in the underlying hash function. In particular, the system only accepts a syndrome—hash pair (S, H) in the authentication phase 310 if the hash H′ of the decoded biometric E″ matches the original hash H. For cryptographic hash functions, such as MD5, finding an element E″, which differs from E, but has a hash that matches the hash of E is generally considered impossible. Thus, if syndrome decoding succeeds in decoding E″ with the proper hash, the system can be confident that E″ is in fact the same as E, and all authentication decisions are made with the original biometric parameters.

Third, the invention compresses the original biometric parameters E in producing the syndrome S. Biometric databases for many users can require large amounts of storage, especially if the biometric data question requires large amounts of data, e.g., face images or speech signals. Therefore decreasing the storage required can yield drastic improvements in both cost and performance. In contrast, most prior art methods for the secure storage of biometric data actually increase size of the stored data due to the overhead of encryption or error correction, and therefore require more storage than insecure systems.

Fourth, the invention can apply sophisticated code construction and decoding algorithms because the invention is built on the theory of syndrome codes. In particular, the syndrome coding according to the invention facilitates the use of soft decoding using the well known Viterbi algorithm, belief propagation, and turbo decoding for both binary and multilevel code constructions. In contrast, because most prior art methods are based on binary codes, Reed-Solomon codes, and algebraic decoding, soft decoding cannot be applied effectively when the biometric data take on real values, as opposed to binary values. For example, some methods specifically require computing the XOR of the biometric data with a random codeword in the enrollment phase to produce the reference and requires computing the XOR of the reference with the biometric data in the authentication phase.

Fifth, while most prior art on secure biometrics using error correction encoding, the invention uses syndrome encoding. The computational complexity of error correction encoding is usually super linear in the input size. In contrast, by using various types of low density parity checks based syndrome codes, it is easy to construct syndrome encoders where the computational complexity of the syndrome encoding is only linear in the input size.

Sixth, by using the syndrome coding framework, it is possible to use powerful new embedded syndrome codes as the SCA codes described by Yedidia et al. These codes allow the syndrome encoder, during enrollment, to estimate an inherent variability of biometric data, and encode just enough syndrome bits to allow successful syndrome decoding.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method securely storing biometric parameters in a database, comprising:
encoding enrollment biometric parameters of a user using a syndrome encoder to produce an enrollment syndrome;
applying a hash function to the enrollment syndrome to produce an enrollment hash; and
storing the enrollment syndrome and the enrollment hash in a database.

2. The method of claim 1, further comprising:
acquiring enrollment biometric data from a user; and
extracting the enrollment biometric parameters from the enrollment biometric data.

3. The method of claim 2, in which the enrollment biometric data is an image of a face.

4. The method of claim 2, in which the enrollment biometric data is a recording of a voice.

5. The method of claim 2, in which the enrollment biometric data is an image of a fingerprint.

6. The method of claim 2, in which the enrollment biometric data is an image of an iris.

7. The method of claim 1, in which the hash function is a cryptographic hash function.

8. The method of claim 1, in which the syndrome encoder is a Slepian-Wolf encoder.

9. The method of claim 1, in which the syndrome encoder is a Wyner-Ziv encoder.

10. The method of claim 1, in which the syndrome encoder uses a serially concatenated accumulate code.

11. The method of claim 1, in which the enrollment biometric parameters have integer values.

12. The method of claim 1, in which the syndrome code is a compression of the enrollment biometric parameters.

13. The method of claim 1, in which the syndrome encoder is rate-adaptive.

14. The method of claim 1, in which the syndrome encoder is incremental.

15. The method of claim 1, further comprising:
acquiring authentication biometric parameters from the user;
decoding the enrollment syndrome using a syndrome decoder and the authentication biometric parameters to produce decoded biometric parameters;
applying the hash function to the decoded biometric parameters to produce an authentication hash; and
comparing the authentication hash and the enrollment hash to determine whether access is granted.

16. The method of claim 15, further comprising:
comparing the authentication biometric parameters to the decoded enrollment biometric parameters to confirm whether access is granted.

17. The method of claim 15, in which the syndrome decoder uses belief propagation.

18. The method of claim 15, in which the syndrome decoder uses turbo codes.

19. The method of claim 15, in which the syndrome decoding uses a Viterbi algorithm.

20. A system for securely storing biometric parameters in a database, comprising:
means for acquiring enrollment biometric parameters from a user;
a syndrome encoder configured to encode the enrollment biometric parameters as an enrollment syndrome;
a hash function configured to produce an enrollment hash from the enrollment syndrome; and
a database configured to store the enrollment syndrome and the enrollment hash.

21. The system of claim 20, further comprising:
means for acquiring authentication biometric parameters from the user;
a decoder configured to decode the enrollment syndrome using the authentication biometric parameters to produce decoded biometric parameters;
means for applying the hash function to the decoded biometric parameters to produce an authentication hash; and
means for comparing the authentication hash and the enrollment hash to determine whether access is granted.

22. A method for securely storing biometric parameters in a database and authenticating users, comprising:
encoding enrollment biometric parameters of a user using a syndrome encoder to produce an enrollment syndrome;
applying a hash function to the enrollment syndrome to produce an enrollment hash;
decoding the enrollment syndrome using a syndrome decoder and authentication biometric parameters of the user to produce decoded biometric parameters;
applying the hash function to the decoded biometric parameters to produce an authentication hash; and
comparing the authentication hash and the enrollment hash to determine whether access is granted.
